(19) United States
(12) Patent Application Publication
(10) Pub. No.: US 2006/0202846 A1
(43) Pub. Date: Sep. 14, 2006

(54) Ceiling leak prevention system

(76) Inventor: Michael Garabedian, Newton, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/065,969

(22) Filed: Feb. 25, 2005

(51) Int. Cl. G08B 21/00; B65D 51/00; B65D 1/34

(52) U.S. Cl. 340/618; 206/557; 220/200

(57) ABSTRACT

The present invention includes a system of trays for containing leaking liquids above a ceiling. The trays have extended sides to hold a volume of liquid. One side of a tray is lower than other sides of the tray. When a large volume leak occurs, the liquid fills the tray to the height of the lower side and flows over the lower side into an adjacent tray. The system of trays includes a tray with a drain. The system of trays may also incorporate sensors in the trays. The sensors can operate to actuate a valve for shutting off the leaking liquid, and may also send a message communicating the occurrence of the leak.

### BACKGROUND

1. Field Of The Invention

The present invention relates to liquid damage prevention. More specifically, it relates to a ceiling leak diversion system.

2. Discussion Of The Related Art

In some residential buildings, and many commercial buildings, pipes carry liquid above ceilings in offices, storage spaces or living spaces. At times plumbing leaks occur which pour large volumes of water onto the ceiling. The water quickly goes through the ceiling and destroys computer equipment, books, hardwood floors, paintings and other valuables in the spaces below. In commercial space and vacation homes this problem is especially drastic if the leak occurs when the building is not occupied because the leak may continue undetected for hours or days. Various systems have been developed which operate to detect and control leaks.

Systems have been designed as permanent ceiling tile replacements to capture small roofing leaks or small plumbing drips. One system designed for a hung ceiling includes a tray for retaining a small amount of liquid. A sensor detects the presence of liquid and sounds an alarm to alert the occupants of a leak. This system does not address the problem of large plumbing leaks. Although the alarm sounds when a large leak occurs, all of the water from the leak cannot be contained in the tray. Additional water will overflow and property below the ceiling may be damaged. Furthermore, the alarm is useless when the building is unoccupied.

Another system is designed as a temporary ceiling tile replacement. The system employs a tray placed in the ceiling after a small leak is detected to capture and drain away a small amount of liquid. The tray has a small capacity for water retention and a small capacity for drainage. This is a temporary solution until a small leak can be repaired. The system employs a small drain tube which comes into the interior of the room. This system will not prevent a large leak from damaging property because it is not placed until after a leak is discovered. Also, the drainage is insufficient to handle a large volume of liquid.

Other systems teach connecting hoses from holes in each of multiple trays to facilitate drainage from a large area. Such systems have the undesirable feature of multiple hoses visible in living or office space where the system is installed. These systems also require a large amount of effort to set up with hoses connecting to each tray and, in some such systems, multiple hoses connecting to each tray. Each hole and hose connection further provides a disadvantage in the higher possibility of a leak from the system itself where hoses connect to trays.

### SUMMARY OF THE INVENTION

The present invention provides a leak prevention system which installs easily, prevents large liquid leaks from damaging property, and does not require hoses attached to each tray. The present invention includes a system of catch trays. According to one aspect of the invention, at least one tray in the system can hold a volume of liquid and has at least one side of the tray lower than other sides of the tray. When a large volume leak occurs, the trays hold substantial amounts of liquid. If the leak is larger than a tray can hold, the liquid will flow over the lower side into an adjacent tray. The liquid continues to fill adjacent trays, containing the leaking liquid within the system of multiple trays. According to another aspect of the invention, the system of trays includes a tray with a drain. When a tray adjacent to the tray with a drain fills, liquid flows into the drain tray and is drained away. According to another aspect of the invention, the system of trays incorporates sensors in the trays for detecting the occurrence of a leak. The sensors can actuate a valve for shutting off a source of leaking liquid, send a message communicating the occurrence of the leak, or take other action in response to detection of a leak. According to another aspect of the invention, each catch tray in the system of trays has a lip for preventing liquid from spilling between catch trays as the liquid flows from one catch tray into an adjacent catch tray. According to other aspects of the invention, catch trays utilize different lip designs and sealing techniques to prevent leaks between trays.

### BRIEF DESCRIPTION OF THE DRAWINGS

FIG. 1 is an isometric view of a catch tray according to an embodiment of the invention.

FIG. 2 is a cross sectional view of a system of catch trays according to another embodiment of the invention.

FIGS. 3A and 3B are cross section views of additional embodiments with extending lips for joining trays.

FIGS. 4A, 4B, and 4C are cross section views of additional embodiments with extending lips for joining trays.

FIG. 5 is a cross section view of another embodiment with extending lips for joining trays.

FIG. 6 is a cross section view of a system of catch trays according to another embodiment of the invention.

### DETAILED DESCRIPTION

The structures shown and described are by way of example, and may be formed using many different materials or variations in structure currently known to exist without departing from the invention described.

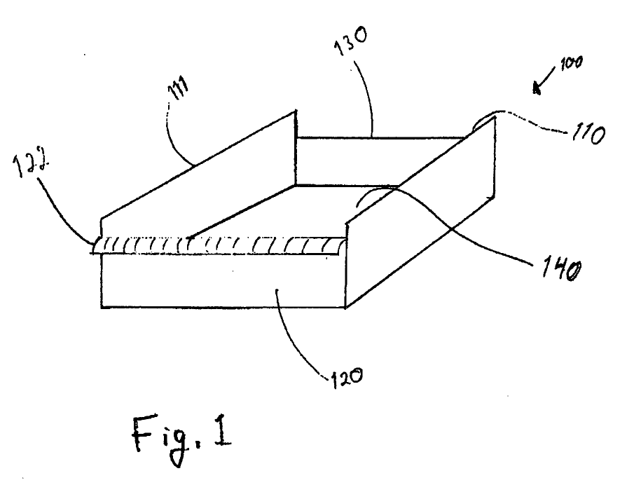

Referring to FIG. 1, an embodiment of a catch tray 100 is shown which is useful in the leak prevention system of the present invention. The catch tray 100 may function in a ceiling with standard drop ceiling tiles. Although it may have many different shapes and sizes, preferably it is the size of a standard ceiling tile. According to an embodiment of the invention, the catch tray 100 has a length of 48 inches and a width of 24 inches. The catch tray has a base part 140, a front end 120, a back end 130, and two sides 110, 111. The height of the front end 120 should be sufficient for the catch tray 100 to hold water from a large plumbing leak. The base part 140 may be the same dimensions in length and width as the entire catch tray 100. The base part 140 may have a length or width which is greater or less than the length or width of the rest of the catch tray 100. The base part 140 may define only a length or a width such that the sides 110, 111, or the front end 120 and the back end 140 form slopes which meet.

According to an embodiment of the invention the height of the front end 120 is 1½ inches. The catch tray 100 holds approximately 60 pounds or approximately 7.5 gallons of water. The height of the front end 120, may be the lowest side or may be the same height as another side. The height of the lowest side will define the volume of liquid which the catch tray 100 holds. The lowest side may have lower or higher edge, so that the catch tray holds less or more liquid. The ceiling structure, whether a finished ceiling, or a hung grid, can be constructed to accommodate the weight of the catch tray 100 when it is full of water or other liquid.

According to an embodiment of the invention, the leak prevention system has a front end 120 which has a height above the base part 140 that is less than the height of any other sides. In an embodiment of the invention the height of the back end 130 is the same height as the sides 110, 111. The base part 140 is defined by a flat surface. The sides 110, 111 are defined as perpendicular to the flat surface defining the base part 140. The sides are not required to be perpendicular to the flat surface, but may be angled so that they come together. The base part 140 is not always defined by a flat surface but may also be a point where sloping sides come together. The sides 110 are not required to be a flat surface, but may also be a curving surface.

The material used to make the tray may be metal, plastic, or wood. The catch tray has sufficient strength to support accumulated water. According to an embodiment of the invention, a plastic material is used with a thickness of ⅛ inch. The plastic material may meet one of several different standards for fire safety. According to an embodiment of the invention, the leak prevention system is supported by a ceiling tile grid which is designed to hold the weight of several catch trays filled with liquid. If the catch trays hold a larger volume of water the supports for the ceiling tile grid may need to be modified to support the increased weight. For example, if the catch tray dimensions are 48 inches by 24 inches by 7.5 inches in height, then the catch tray can hold approximately 37 gallons which is approximately 300 pounds of water. The ceiling tile grid may be constructed to support such a weight.

When a problem such as a broken pipe occurs above the ceiling the catch tray retains a large amount of water. As shown in FIG. 1, the catch tray 100 has a front end 120, which is shorter than the sides 110, 111. Water may flow over the front end 120 into a second catch tray (not shown in FIG. 1) when a large liquid leak fills the first catch tray 100. The front end 120 is shown in this example with an extending lip 122. The extending lip 122 allows the liquid to flow from the first catch tray 100 into the second catch tray (not shown in FIG. 1). The extending lip 122 is of sufficient length to minimize spilling between the catch trays.

According to an embodiment of the invention, the leak prevention system comprises two identical catch trays in accordance with the catch tray 100 shown in FIG. 1. When the liquid flows from a catch tray 100, it flows into an adjoining catch tray identical to the catch tray 100. The side of the tray which is opposite the front end 120 is the back end 130, and is of a height to allow liquid to flow from an adjoining catch tray over the back end 130. The back end 130 may include an extending lip to prevent liquid from spilling as the liquid flows from one catch tray into the adjoining catch tray.

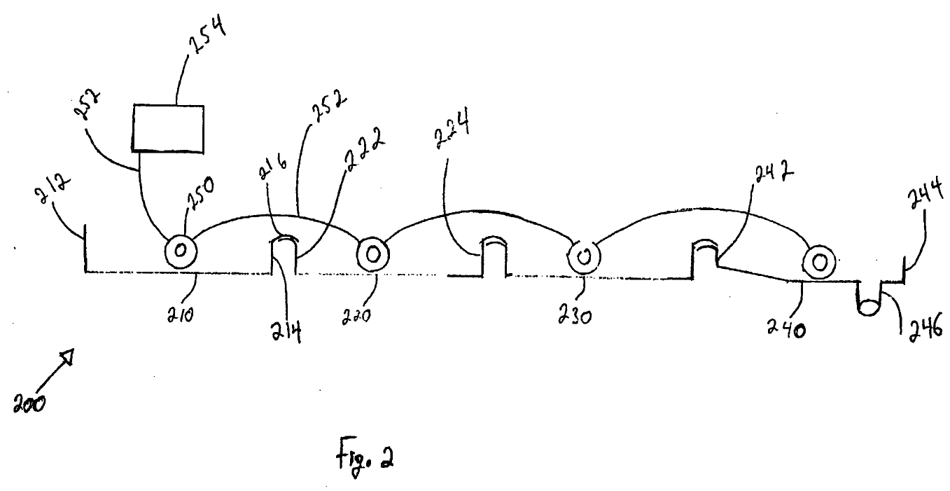

Referring to FIG. 2, according to an embodiment of the invention, a leak prevention system 200 includes a plurality of adjoining catch trays. A first catch tray 210 may be situated next to a wall or at the end of an area where liquid leak protection is desired. A second catch tray 220 is situated next to the first catch tray 210. The first catch tray 210 has a back end 212 which is higher than a front end 214. The second catch tray 220 has a back end 222 which is the same height as the front end 224 and is also the same height as the front end of the first catch tray 214. According to an embodiment of the invention, when the liquid captured in the first catch tray 210 fills the first tray, it will flow over the front end of the first catch tray 214 into the second catch tray 220. The first catch tray has an extending lip 216 to prevent liquid spills between trays.

According to the embodiment of the invention illustrated in FIG. 2, the leak prevention system has a third catch tray 230 which is identical to the second catch tray 220. A plurality of identical catch trays may be placed between the first and last catch tray in a row. The last catch tray 240 has a back end 242, a front end 244, and a drain 246. The height of the back end 242 is the same as the height of the front end of the first tray 214. In the example shown in FIG. 2, when liquid flows into the third tray 230 and then into the last tray 240 the liquid will flow into a drain 246 which may be connected to a sewer pipe (not shown).

According to an embodiment of the invention, the leak prevention system has a drain 246 which is large enough to drain a large volume of water quickly. The drain preferably has a 1 inch diameter. The drain 246 is connected to a pipe which will direct liquid into a barrel, other receptacle, or the sewage system of the building. The drain 246 is illustrated in FIG. 2 as near one edge of the tray. It may be placed at the center of the tray or near any edge of the tray. The function of the drain 246 is to remove water from the last tray 240 so that the water does not fill the last tray 240. The drain 246 may be of a larger or smaller diameter so long as the diameter of the drain allows drainage without the last tray 240 overfilling. When the leak prevention system 200 is installed below a large high pressure pipe, or multiple pipes, a larger drain, or multiple draining trays may be necessary to prevent any draining trays from overflowing.

When the leak prevention system is configured with multiple catch trays, the leaking liquid may first fall into any of the trays, whether in the middle of the row of trays, at an end without a drain, or at an end with a drain. The system of trays may be configured such that the liquid only flows in the direction of a drain when the first tray catching liquid overflows. The system of trays may also be configured so that the liquid flows in multiple directions when the first tray catching liquid overflows.

According to another embodiment of the invention, the leak prevention system consists of only a first tray 210 of FIG. 2, situated next to a last tray 240, without the second or third trays.

According to an embodiment of the invention, the leak prevention system of FIG. 2 has liquid sensor, 250 in each tray, which sends a signal through a wire 252, to a control box 254. The sensor 250 does not need to be placed in every catch tray, but may be placed in catch trays below locations where a leak is more likely to occur. As illustrated in FIG. 2, the sensors 250 are connected in series into one control box. The sensors may also be connected in parallel, or with only one sensor being connected to one control box. Liquid sensors and control boxes are commercially available, and can be configured with many more than 4 sensors for one control box. According to another embodiment of the invention, the connection 252 between the sensors 250 and the control box 254 may be a wireless signal. Also, the control box 254 may initiate several devices, for example sounding an alarm, shutting a valve, or sending a message through the Internet, a telephone system, or a local communication system.

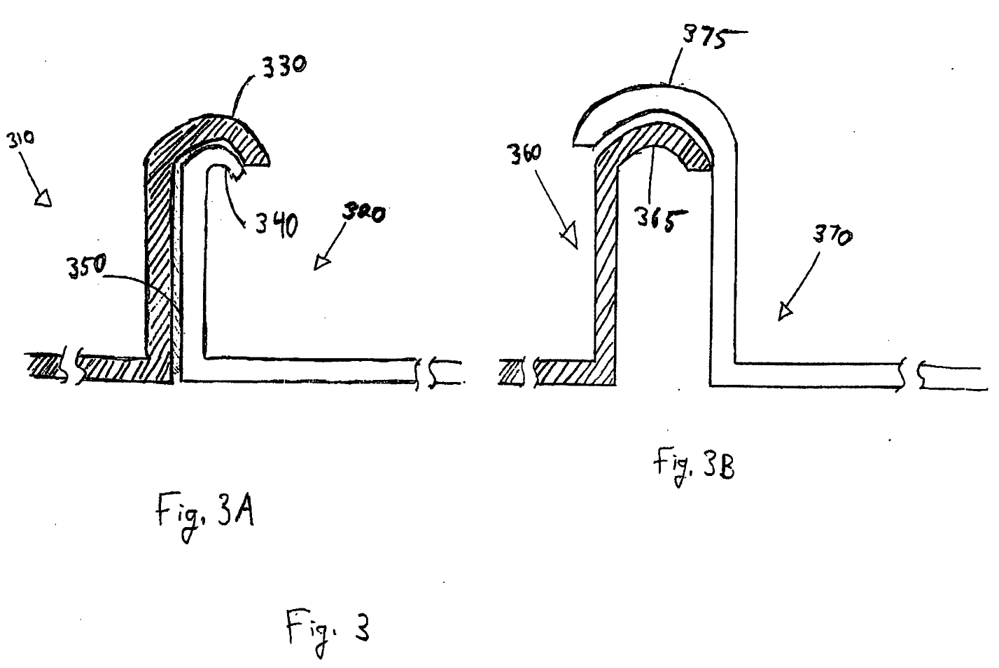

According to an embodiment of the invention, the leak prevention system includes adjoining trays with extending lips. Referring to FIG. 3A, an exploded view from FIG. 1 of the extending lip 122 is shown. FIG. 3A shows a first extending lip 330, from a first catch tray 310, over a second catch tray 320. A second extending lip 340 extends from the second catch tray 320 towards the inside of the second catch tray. The structure of the lips prevents liquid from entering a space 350 between the trays. According to an embodiment of the invention, the space 350 is filled with sealant to further prevent liquid from entering the space 350 between the catch trays. A filler is shown occupying the entire space between the catch trays, but the filler may occupy only some of the space between the catch trays sufficient to create a seal, for example the filler may only occupy the space between the first lip 330, and the second lip 340.

Referring to FIG. 3B an embodiment of the invention has a first tray 370 having a first extending lip 375, and a second tray 360 having a second extending lip 365. FIG. 3B is an exploded view from FIG. 2 of the extending lip 216. The height of the first extending lip 375 is slightly less than the height of the second extending lip 365. When the first tray 370 and the second tray 360 are placed on a flat surface such as that above a finished ceiling, or on a grid of ceiling tiles, the first extending lip 375, presses down on the second extending lip 365, preventing liquid from entering the space between the trays. According to an embodiment of the invention, the leak prevention system is assembled with the second tray 360 closer to the drain than the first tray 370. When the first tray 370 fills with liquid the weight of the liquid causes the first extending lip 375 to press firmly against the second extending lip 356 as liquid flows from the first tray 370 into the second tray 360.

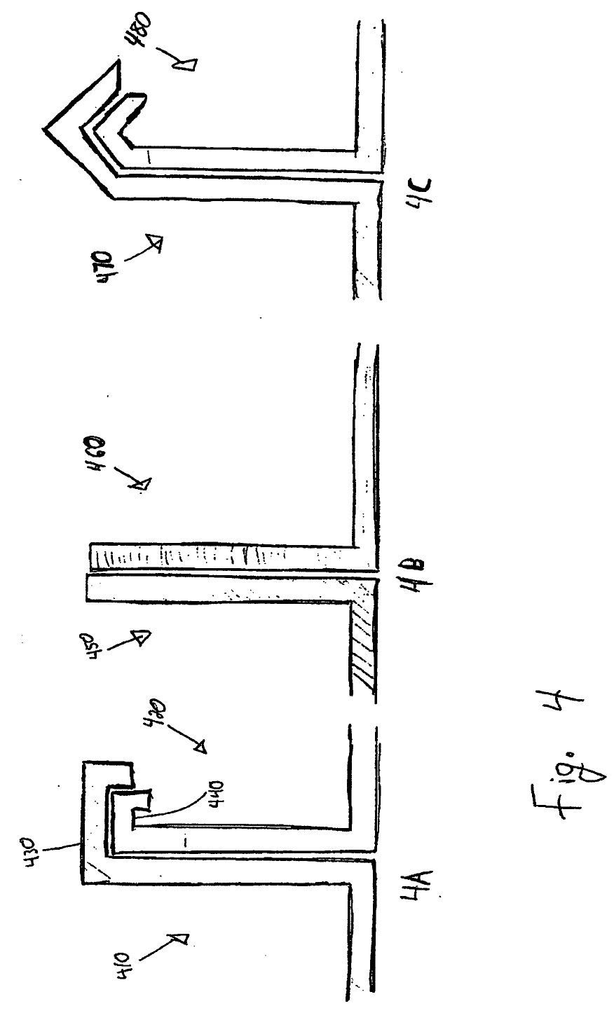

Referring to FIGS. 4A-4C, additional embodiments of the invention are shown for adjoining catch trays. In FIG. 4A, a method of joining catch trays is shown which is useful in the leak prevention system. The first tray 410, adjoins a second tray 420, the first extending lip 430 is a square lip, which functions to fit tightly around a second extending lip 440.

In FIG. 4B, another embodiment of joining catch trays is shown which is useful in the leak prevention system. A first tray 450 adjoins a second tray 460 and the trays are joined together by placing sealant between the trays. In other embodiments of the invention the trays are joined by the use of adhesives, or by magnetism through magnetic strips. The trays may also be placed next to each other with only the pressure of the first tray 450 against the second tray 460 limiting the liquid that may flow between the trays. The method of joining trays may allow some liquid to flow between trays, but the volume of this liquid is very small compared to the amount of liquid which is retained by the catch tray, or compared to the amount of liquid which is directed into an adjacent catch tray.

FIG. 4C illustrates a further embodiment of the invention which includes lips angled with straight edges sloping to direct liquid into the first tray 470 and the second tray 480.

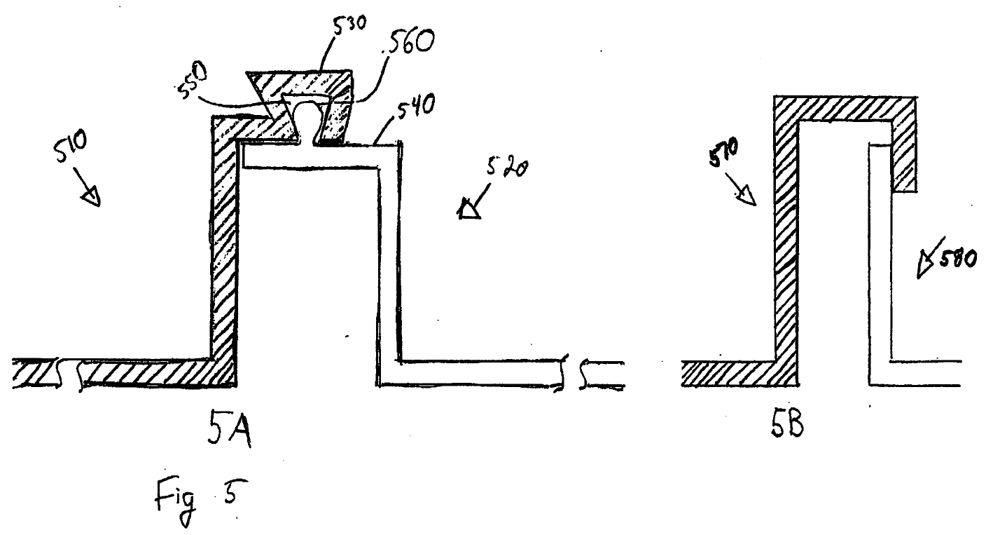

FIG. 5A shows an embodiment of a leak prevention system including a first tray 510 with a first extending lip 530, connected to a second tray 520 with a second extending lip 540. The first extending lip 530 when formed from a plastic material deforms and connects with pressure sufficient to prevent liquid from flowing between the first tray 510 and the second tray 520. The first extending lip 530 forms a cavity 550 which is wider at the top of the cavity than at the bottom of the cavity. The second extending lip 540 is formed with a structure 560 designed to fit in the cavity 550 formed by the first extending lip 530, where the top of the structure 560 is larger than the bottom of the structure 560. The first extending lip 530 forming the cavity 550, is not required to be larger on the top of the cavity than on the bottom of the cavity, and may be situated below the structure 560 designed to fit inside it.

In another embodiment of the invention a system of catch trays has joining trays as shown in FIG. 5B. A first tray 570 has an extending lip which extends over the edge of a second tray 580. Although it is not necessary, the first tray 570 is in contact with the second tray 580.

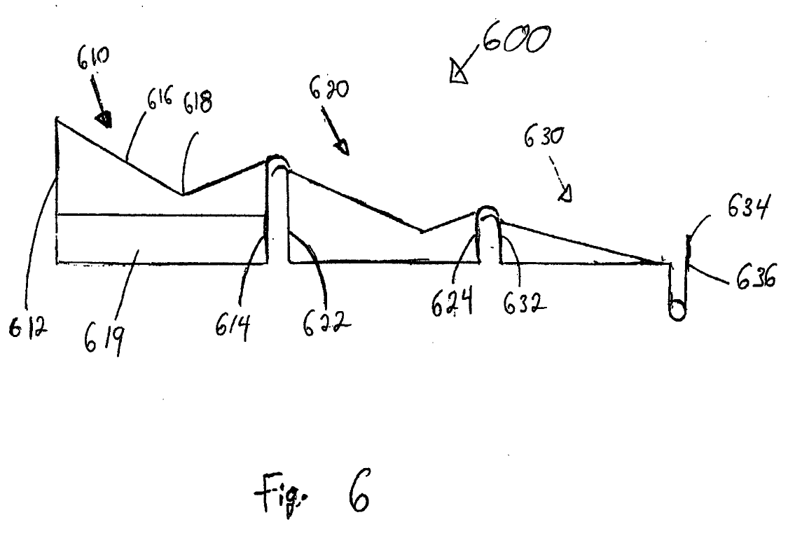

Referring now to FIG. 6 a leak prevention system 600 includes a system of catch trays. According to an embodiment of the invention, the leak prevention system 600, includes a first tray 610, a second tray 620, and a third tray 630. The first tray 610 has a back edge 612. The back edge 612 is higher than a front edge 614 by one half inch. The first tray 610 has a sloping interior 616 which forms a base part 618. When a liquid detection sensor (shown as 250 in FIG. 2) is placed at the base part 618, the embodiment of the leak prevention system has the advantage of easily detecting small leaks. The first tray 610 has a bottom extension 619. The bottom extension 619 may be an integral part of the first tray.

In another embodiment of the invention of FIG. 6, the bottom extension 619 is a support placed under the tray. The height of the bottom extension 619 is one half inch, the same height as the difference between height of the back edge 612 and the front edge 614. When the bottom extension 619 of the first tray 610 is not an integral part of the tray, but is a separate support for the tray, then the first tray 610 and the second tray 620 can be produced from the same pattern. The bottom part support 619 is then added under the first tray 610.

According to an embodiment of the invention, the leak prevention system 600 has a third tray 630 with a back edge 632 and a front edge 634. The third tray back edge 632 adjoins the second tray 620 and is the same height as the front edge of the second tray 624. The third tray 630 has a drain 636 which is connected to a standard drainage system where the leak prevention system 600 is used.

When the bottom extension 691 is the same height as the difference between the height of the front edge 614, and the height of the back edge 612, then when the first tray 610 is placed with the front edge 614 adjacent to the back edge 622 of the second tray 620, the height of the front edge 614 is approximately the same height as the back edge 622. In this manner the liquid is directed to always flow in the direction of the drain 636 when a tray overflows.

When the leak prevention system is produced according to the example in FIG. 6 a tray will capture leaking liquid and fill to capacity. Then the liquid will only flow over the front edge because the front edge of each tray is lower than the back edge of each tray. In this way the liquid will only fill the trays between the leaking liquid and the last tray with a drain 630. According to an embodiment of the invention, the leak prevention system 600 has more than three trays, installed in a row. Additional bottom extensions 619 are placed under each tray which is not adjacent to the tray with the drain 630. In this way the front edge of each tray with additional bottom extensions 619 will be the same height as the back edge of the adjacent tray.

To empty any of the catch trays when it has become filled, several methods may be employed. For example a pump system may be used to direct the liquid to the catch tray with a drain. This would need to be repeated for each of the catch trays which becomes filled with water. A second example may be tilting each catch tray with liquid so that the liquid from one tray will drain into the next tray which is closer to the drain. This method allows the trays to be emptied before removing any of the tiles to gain access to the area of the liquid leak. It may not be discernable which of the catch trays contain liquid and which do not. When the catch trays are used with a sensor, an individual catch tray, or a zone of catch trays may send a signal to communicate which catch trays contain liquid. If each catch tray at the edge of the zone is tilted, and then each catch tray closer to the drain is tilted, all of the catch trays may be emptied into the drain without the use of a pump.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

1. A tray for catching leaking liquid comprising:
a base part;
a plurality of sides extending from the base part to form a volume above the base part; wherein at least one of the plurality of sides has a height above the base part which is lower than at least another of the plurality of sides.

2. The tray according to claim 1, wherein the plurality of sides includes at least four sides, and wherein one side has a first height, and at least two other sides have a second height greater than the first height.

3. The tray according to claim 1, wherein the plurality of sides includes at least four sides, and wherein two sides have a first height, and at least two other sides have a second height greater than the first height.

4. The tray according to claim 1, wherein the base part includes a drain.

5. The tray according to claim 1, wherein at least one of the plurality of sides includes an extending lip.

6. The tray according to claim 5, wherein the extending lip is rounded.

7. The tray according to claim 5, wherein the extending lip is square.

8. The tray according to claim 1, wherein at least a portion of the base part is sloped.

9. The tray according to claim 1, further comprising a liquid detection sensor within the volume.

10. A system of trays for catching leaking liquid comprising:
a plurality of trays, each tray having
a base part;
a plurality of sides extending from the base part to form a volume above the base part;
wherein at least one of the plurality of sides has a height above the base part which is lower than the height of at least another of the plurality of sides;
wherein a lower side of a tray is adjacent to one side of an adjacent tray, and wherein at least one of the plurality of trays includes a drain.

11. The system of trays for catching leaking liquids according to claim 10, wherein at least one of the plurality of trays further comprises a bottom extension below the base part, and wherein the plurality of trays is at least three trays.

12. The system of trays for catching leaking liquids according to claim 10, wherein each tray includes at least one edge containing an extending lip.

13. The system of trays for catching leaking liquids according to claim 11, wherein each trays includes at least one edge containing an extending lip.

14. The system of trays for catching leaking liquids according to claim 10, wherein the adjacent sides are sealed together.

15. The system of trays for catching leaking liquids according to claim 14, wherein the sealing is accomplished with adhesive.

16. The system of trays for catching leaking liquids according to claim 14, wherein the sealing is accomplished using a flexible removable bond.

17. The system of trays for catching leaking liquids according to claim 14, wherein the sealing is accomplished by pressure.

18. The system of trays for catching leaking liquids according to claim 11, wherein the base part of each tray has at least one sloping surface.

19. A system of trays for catching leaking liquid comprising:
a plurality of catching trays, each tray having:
a bottom surface;
a front end extending above the bottom surface;
a back end extending above the bottom surface;
a plurality of sides extending above the bottom surface;
wherein the front end, the back end, and the plurality of sides forms a volume above the bottom surface;
wherein the back end has a height above the bottom surface which is less than the height of the plurality of sides;
wherein the front end has a height above the bottom surface which is less than the back end height above the surface;
a draining tray, wherein the draining tray comprises:
a bottom surface, comprising a drain;
a plurality of sides extending from the bottom surface to form a volume above the bottom surface;
the system of trays is arranged such that one of the plurality of sides of at least one catching tray is adjacent to at least one of the plurality of sides of the draining tray.

20. The system of trays for catching leaking liquids according to claim 19, further comprising
at least one additional catching tray, wherein the additional catching trays are further comprised by bottom extensions below the bottom surface,
the additional catching trays are arranged such that the front end of a first additional catching tray adjoins the back end of the catching tray, and the bottom surface of the first additional catching tray is higher than the bottom surface of the catching tray.

21. The system of trays for catching leaking liquids according to claim 21, wherein each tray further comprises a liquid detection sensor.

22. The system of trays for catching leaking liquids according to claim 21, wherein the liquid detection sensors are communicatively connected to at least one control box, wherein the control box actuates a valve to shut off a source of leaking liquids.
